(19) United States
(12) Patent Application Publication
(10) Pub. No.: US 2026/0065066 A1
(43) Pub. Date: Mar. 5, 2026

(54) APPARATUS AND METHOD FOR OFFLINE PREFERENCE-BASED REINFORCEMENT LEARNING

(71) Applicant: SEOUL NATIONAL UNIVERSITY R&DB FOUNDATION, Seoul (KR)

(72) Inventors: Taesup MOON, Seoul (KR); Heewoong CHOI, Seoul (KR); Sangwon JUNG, Seoul (KR); Hongjoon AHN, Seoul (KR)

(21) Appl. No.: 18/916,884

(22) Filed: Oct. 16, 2024

(30) Foreign Application Priority Data
Aug. 27, 2024 (KR) 10-2024-0115391

(51) Int. Cl. G06N 3/092

(52) U.S. Cl. CPC G06N 3/092

(57) ABSTRACT

The embodiments disclosed herein are directed to a reinforcement learning apparatus and method. According to an embodiment, there is provided a reinforcement learning apparatus for performing offline preference-based reinforcement learning, the reinforcement learning apparatus including: memory configured to store a program and a dataset for performing reinforcement learning; and a controller provided with at least one processor, adapted to operate by executing the program stored in the memory, and configured to construct a ranked list of trajectories (RLT) by repeating the tasks of extracting a trajectory segment and adding the trajectory segment to the RLT, in which trajectory segments are sorted by preference level, based on preference feedbacks for a trajectory pair including the trajectory segment a plurality of times, and to train a reward model based on preference pairs each including two trajectory segments extracted from the RLT and a preference label assigned to the two trajectory segments.

### CROSS-REFERENCE TO RELATED APPLICATION

This application claims the benefit of Korean Patent Application No. 10-2024-0115391 filed on Aug. 27, 2024, which is hereby incorporated by reference herein in its entirety.

### BACKGROUND

### 1. Technical Field

The embodiments disclosed herein relate to an apparatus and method for offline preference-based reinforcement learning.

The embodiments disclosed herein were derived as a result of the research on the task “Research on Novel Continual Learning Algorithms with Practical Constraints on Data and Environments” (task management number: NRF-2021R1A2C2007884) of the Individual Fundamental Research Project that was sponsored by the Korean Ministry of Science and ICT and the National Research Foundation of Korea.

The embodiments disclosed herein were derived as a result of the research on the task “Artificial Intelligence Graduate School Program (Seoul National University)” (task management number: IITP-2021-0-01343) of the Information, Communications and Broadcasting Innovative Talent Nurturing Project and the task “Developing a Sustainable Collaborative Multi-modal Lifelong Learning Framework” (task management number: IITP-2022-0-00113) of the Human-Centered Artificial Intelligence Core Source Technology Development Project that were sponsored by the Korean Ministry of Science and ICT and the Institute of Information & Communications Technology Planning & Evaluation.

### 2. Description of the Related Art

In general, reinforcement learning is one of the methods of learning through trial and error, and refers to a method in which an agent recognizes a current state in an environment and learns actions or policies that maximize rewards among selectable actions. Reinforcement learning may be used to train an agent such as an autonomous driving robot as disclosed in Korean Patent Application Publication No. 10-2021-0048969.

Meanwhile, offline reinforcement learning performs reinforcement learning by using a fixed offline dataset. Unlike general reinforcement learning that performs reinforcement learning through interaction with an environment, offline reinforcement learning performs learning without interaction with an environment.

In both general reinforcement learning and offline reinforcement learning, the design of a reward function is the most important. To overcome difficulty in designing an effective reward function, recently, there has been proposed offline preference-based reinforcement learning that trains a reward model based on preference feedbacks obtained from humans and applies the trained reward model to reinforcement learning.

Meanwhile, the above-described background technology corresponds to technical information that has been possessed by the present inventor in order to contrive the present invention or that has been acquired in the process of contriving the present invention, and can not necessarily be regarded as well-known technology that had been known to the public prior to the filing of the present invention.

### SUMMARY

An object of the embodiments disclosed herein is to propose an apparatus and method for offline preference-based reinforcement learning that train a reward model by using a ranked list of trajectories (RLT) in which the preference levels of all trajectory segments are assigned based on preference feedbacks.

According to an aspect of the present invention, there is provided a reinforcement learning apparatus for performing offline preference-based reinforcement learning, the reinforcement learning apparatus including: memory configured to store a program and a dataset for performing reinforcement learning; and a controller provided with at least one processor, adapted to operate by executing the program stored in the memory, and configured to construct a ranked list of trajectories (RLT) by repeating the tasks of extracting a trajectory segment and adding the trajectory segment to the RLT, in which trajectory segments are sorted by preference level, based on preference feedbacks for a trajectory pair including the trajectory segment a plurality of times, and to train a reward model based on preference pairs each including two trajectory segments extracted from the RLT and a preference label assigned to the two trajectory segments.

According to another aspect of the present invention, there is provided a reinforcement learning method performed by a reinforcement learning apparatus, the reinforcement learning method including: constructing a ranked list of trajectories (RLT) by repeating the tasks of extracting a trajectory segment and adding the trajectory segment to the RLT, in which trajectory segments are sorted by preference level, based on preference feedbacks for a trajectory pair including the trajectory segment a plurality of times; and training a reward model based on preference pairs each including two trajectory segments extracted from the RLT and a preference label assigned to the two trajectory segments.

According to still another aspect of the present invention, there is provided a non-transitory computer-readable storage medium having stored thereon a program that, when executed by a processor, causes the processor to execute a reinforcement learning method, wherein the reinforcement learning method includes: constructing a ranked list of trajectories (RLT) by repeating the tasks of extracting a trajectory segment and adding the trajectory segment to the RLT, in which trajectory segments are sorted by preference level, based on preference feedbacks for a trajectory pair including the trajectory segment a plurality of times; and training a reward model based on preference pairs each including two trajectory segments extracted from the RLT and a preference label assigned to the two trajectory segments.

According to still another aspect of the present invention, there is provided a computer program that is executed by a reinforcement learning apparatus and stored in a non-transitory computer-readable storage medium to perform a reinforcement learning method, wherein the reinforcement learning method includes: constructing a ranked list of trajectories (RLT) by repeating the tasks of extracting a trajectory segment and adding the trajectory segment to the RLT, in which trajectory segments are sorted by preference level, based on preference feedbacks for a trajectory pair including the trajectory segment a plurality of times; and training a reward model based on preference pairs each including two trajectory segments extracted from the RLT and a preference label assigned to the two trajectory segments.

According to any one of the above-described solutions, more preference pairs may be generated even with a small number of trajectory segments by constructing an RLT in which all extracted trajectory segments are sorted by preference level and then generating preference pairs using the trajectory pairs extracted from the RLT, thereby performing the effective training of a reward model even within a fixed feedback budget.

Furthermore, according to any one of the above-described solutions, preference pairs are generated based on trajectory segments extracted from an RLT sorted by preference level, so that a reward model can be trained on the relative relationships between the generated preference pairs, i.e., secondary preferences, thereby increasing the estimation accuracy of the reward model.

The effects that can be obtained by the embodiments disclosed herein are not limited to the above-described effects, and other effects that have not been described above will be clearly understood by those having ordinary skill in the art, to which the disclosed embodiments pertain, from the following description.

### BRIEF DESCRIPTION OF THE DRAWINGS

The above and other objects, features, and advantages of the present invention will be more clearly understood from the following detailed description taken in conjunction with the accompanying drawings, in which:

FIG. 1 is a block diagram showing the configuration of a reinforcement learning apparatus according to an embodiment;

FIG. 2 is a diagram schematically showing a reinforcement learning process according to an embodiment;

FIG. 3 is a diagram illustrating a framework for performing a reinforcement learning method according to an embodiment;

FIG. 4 is a flowchart illustrating a reinforcement learning method according to an embodiment; and

FIGS. 5 and 6 are diagrams illustrating the performance of a reinforcement learning method according to an embodiment.

### DETAILED DESCRIPTION

Various embodiments will be described in detail below with reference to the accompanying drawings. The following embodiments may be modified to various different forms and then practiced. In order to more clearly illustrate features of the embodiments, detailed descriptions of items that are well known to those having ordinary skill in the art to which the following embodiments pertain will be omitted. Furthermore, in the drawings, portions unrelated to descriptions of the embodiments will be omitted. Throughout the specification, like reference symbols will be assigned to like portions.

Throughout the specification, when one component is described as being “connected” to another component, this includes not only a case where the one component is ‘directly connected’ to the other component but also a case where the one component is ‘connected to the other component with a third component arranged therebetween.’ Furthermore, when one portion is described as “including” one component, this does not mean that the portion does not exclude another component but means that the portion may further include another component, unless explicitly described to the contrary.

Embodiments will be described in detail below with reference to the accompanying drawings.

Meanwhile, prior to the following description, the meanings of the terms to be used below will be defined first.

The term “ternary feedback” may refer to feedback that is defined by one of three types of responses. For example, ternary feedback may be a response for a preference for a specific target that is made using only one of three types of options: “Bad,” “Equal,” and “Good.”

Alternatively, ternary feedback may concern the relative sizes or preferences between two different targets. For example, ternary feedback may be a response in which A is greater than B (i.e., A>B), a response in which A and B are equal (i.e., A=B), or a response in which A is less than B (i.e., A<B) for two targets A and B.

The term “offline reinforcement learning” refers to reinforcement learning performed based on a dataset collected by an unknown policy without an agent's interaction with an environment.

In this case, reinforcement learning may be performed based on an offline dataset and preference feedbacks for trajectory pairs generated from the offline dataset. In the present specification, reinforcement learning based on an offline dataset and preference feedbacks for trajectory pairs generated from the offline dataset is referred to as “offline preference-based reinforcement learning.”

Preference feedbacks are feedbacks obtained from humans on a specific topic. For example, when a person may be asked which of the two trajectories presented to him/her is more advantageous in achieving a goal, the response to the question obtained from the person may be a preference feedback. Preference feedback may be ternary feedback. In other words, preference feedback may be a response for preference for two options made by selecting one of three fixed types of responses. As an example, for trajectories A and B, ternary feedback may be one of the following: the case where A is preferred over B (i.e., A>B), the case where A and B are equal (i.e., A=B), and the case where A is not preferred over B (i.e., A<B). In addition to the terms defined above, terms that require descriptions will be described separately below.

A reinforcement learning apparatus according to an embodiment is an apparatus that performs offline preference-based reinforcement learning. The reinforcement learning apparatus may extract trajectory segments based on a limited dataset, may collect preference feedbacks for the generated trajectory segments, may train a reward model based on the collected preference feedbacks, and may perform reinforcement learning to find an optimal policy that maximizes the cumulative discount reward while taking into consideration general reinforcement learning, i.e., a Markov decision process (MDP), using the trained reward model.

In this case, the reinforcement learning apparatus may extract generated trajectory segments based on the offline dataset, and may generate an RLT based on the preference feedbacks collected for trajectory pairs including the extracted trajectory segments.

For example, the reinforcement learning apparatus may sequentially extract trajectory segments one by one, may determine preference levels for the extracted trajectory segments based on preference feedbacks for trajectory pairs including the extracted trajectory segments, and may add the trajectory segments to the RLT based on the preference levels.

Furthermore, the trajectory segments in the RLT may be sorted based on the preference level, and the RLT may include trajectory segment groups in each of which trajectory segments having the same preference are grouped. The trajectory segment groups may be sorted based on the preference levels corresponding to the trajectory segment groups, and may also be numbered in accordance with the preference levels. More details regarding the RLT will be described later.

Meanwhile, the reinforcement learning apparatus may extract two random trajectory segments from the RLT, may assign preference labels to the extracted trajectory segments, and may generate preference pairs including the trajectory segments and the preference labels. The reinforcement learning apparatus may extract all combinable preference pairs from the RLT, and may determine the values of the preference labels to be assigned to the extracted preference pairs. The preference pairs may be included in a preference dataset.

Furthermore, the reinforcement learning apparatus may train a reward model based on the generated preference pairs, and may train the parameters of the reward model so that the loss function, which is the objective function of the reward model, is minimized. Moreover, general reinforcement learning may be performed using the trained reward model.

The above-described reinforcement learning apparatus may be implemented as an electronic terminal or as a server-client system. When the reinforcement learning apparatus is implemented as a server-client system, it may include a user's electronic terminal for interaction with the user.

In this case, the electronic terminal may be implemented as a computer, a mobile terminal, a television, a wearable device, or the like that can access a remote server or connect with another electronic terminal and a server over a network. In this case, the computer includes, e.g., a notebook, a desktop, a laptop, and the like each equipped with a web browser. The mobile terminal is, e.g., a wireless communication device capable of guaranteeing portability and mobility, and may include all types of handheld wireless communication devices, such as a Personal Communication System (PCS) terminal, a Personal Digital Cellular (PDC) terminal, a Personal Handyphone System (PHS) terminal, a Personal Digital Assistant (PDA), a Global System for Mobile communications (GSM) terminal, an International Mobile Telecommunication (IMT)-2000 terminal, a Code Division Multiple Access (CDMA)-2000 terminal, a W-Code Division Multiple Access (W-CDMA) terminal, a Wireless Broadband (Wibro) Internet terminal, a smartphone, a Mobile Worldwide Interoperability for Microwave Access (mobile WiMAX) terminal, and the like. Furthermore, the television may include an Internet Protocol Television (IPTV), an Internet Television (Internet TV), a terrestrial TV, a cable TV, and the like. Furthermore, the wearable device is an information processing device of a type that can be directly worn on a human body, such as a watch, glasses, an accessory, clothing, shoes, or the like, and can access a remote server or connect with another terminal directly or via another information processing device over a network.

In addition, the server may be implemented as a computing device capable of communicating with the electronic terminal over a network or as a cloud computing server, so that the reinforcement learning apparatus may be implemented as a server-client system.

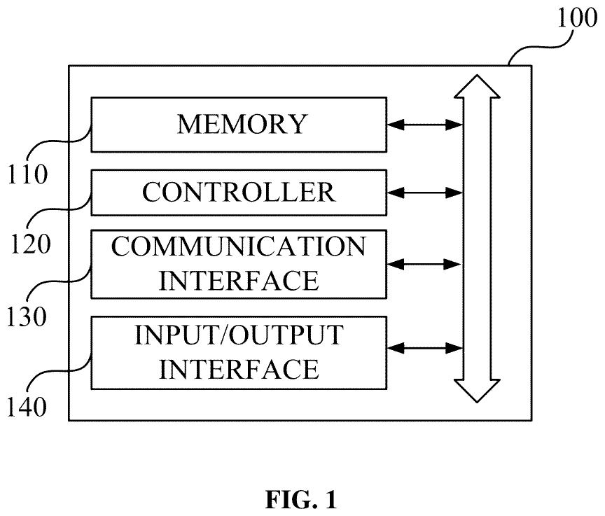

FIG. 1 is a block diagram showing a reinforcement learning apparatus 100 according to an embodiment.

Referring to FIG. 1, the reinforcement learning apparatus 100 according to the present embodiment may include memory 110, a controller 120, a communication interface 130, and an input/output interface 140.

The memory 110 may be constructed using various types of memory such as dynamic random-access memory (DRAM), a solid state drive (SSD), etc., and a program for reinforcement learning and data therefor may be installed and stored in the memory 110. For example, a reinforcement learning method may be installed and stored in the memory 110 in the form of a program. In addition, a dataset collected by an unknown policy, i.e., an offline dataset, may be stored in the memory 110, and a preference feedback for a trajectory pair, which is a combination of any trajectory segments, and an RLT generated by the controller 120 may be stored in the memory 110.

The controller 120 is a component including at least one processor such as a central processing unit (CPU), a graphics processing unit (GPU), or the like, and may perform a reinforcement learning method to be presented below by executing the program stored in the memory 110. For example, the controller 120 may perform reinforcement learning by executing the program, stored in the memory 110, via the processor.

Furthermore, the controller 120 may control other components, included in the reinforcement learning apparatus 100, to perform operations corresponding to the input received through the input/output interface 140. For example, the controller 120 may read a file stored in the memory 110, may store a new file in the memory 110, or may receive an offline dataset collected in advance from another server or device through the communication interface 130 to be described below. A process in which the controller 120 performs offline preference-based reinforcement learning will be described in detail with reference to other drawings below.

Meanwhile, the communication interface 130 may perform wired or wireless communication with another device or a network. As an example, when the reinforcement learning apparatus is implemented as a server-client system, the communication interface 130 may receive a reinforcement learning request, receive preference feedback, or transmit the results of reinforcement learning to a user's electronic terminal while communicating with the user's electronic terminal that accesses the server. Alternatively, the communication interface 130 may receive preference feedback for any trajectory segment combination from another device or the server.

To this end, the communication interface 130 may include a communication module that supports at least one of various wired/wireless communication methods. For example, the communication module may be implemented in the form of a chipset. In this case, the wireless communication supported by the communication interface 130 may be, e.g., Wireless Fidelity (Wi-Fi), Wi-Fi Direct, Bluetooth, Ultra-Wide Band (UWB), Near Field Communication (NFC), and/or the like.

The input/output interface 140 may include an output device such as a display panel or wearable display device for displaying the results or process of reinforcement learning, or a speaker for outputting the results of reinforcement learning or sound as needed when reinforcement learning is performed, and may also include various types of input devices (e.g., a keyboard, a touch screen, a camera, etc.) for receiving preference feedback from a user.

A reinforcement learning method performed by a reinforcement learning apparatus according to an embodiment in such a manner that the controller 120 executes the program stored in the memory 110 will be described in detail below. The processes to be described below are performed in such a manner that the controller 120 executes the program stored in the memory 110 unless otherwise specifically stated.

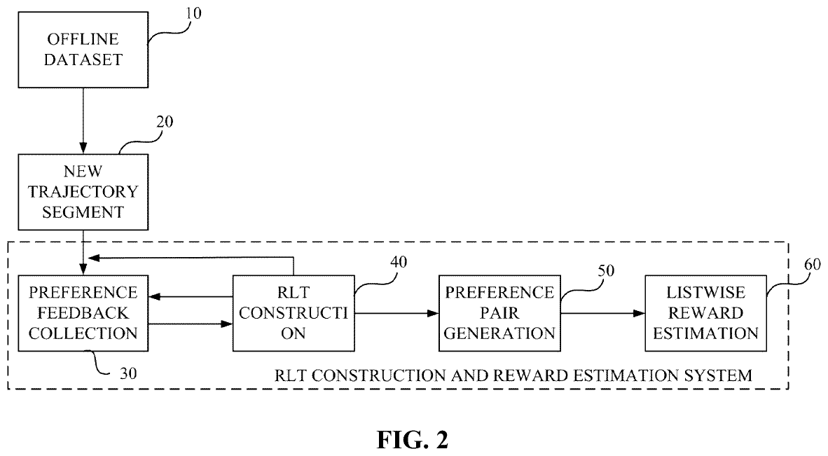

FIG. 2 is a diagram schematically showing a reinforcement learning process according to an embodiment. More specifically, FIG. 2 is a diagram schematically illustrating a process in which a reinforcement learning apparatus according to an embodiment trains an offline preference-based reward model.

Referring to FIG. 2, the controller 120 may generate a set of trajectory segments including trajectory segments generated from an offline dataset 10 collected in advance by an unknown policy u, may extract a new trajectory segment 20 from the generated set of trajectory segments, may collect preference feedbacks collected based on the extracted trajectory segment (see 30), and may construct an RLT in which trajectory segments are sorted by preference level based on the collected preference feedbacks (see 40). Furthermore, the controller 120 may generate preference pairs based on the RLT (see 50), and may train a reward model based on the generated preference pairs. Accordingly, the controller 120 may enable list-wise reward estimation 60 that allows the reward model to learn the preference relationships between all trajectory segments included in the RLT.

The offline dataset 10 may be collected by the unknown policy μ, and may be a set of tuples D₀(D₀:={(s,a,s′)|(s,a)˜μ,s′˜P(·|s,a)} each including a current state S, an action a, and a subsequent state s′.

A trajectory segment may be generated to a predetermined length by combining tuples included in the offline dataset 10, and a trajectory segment set Dₛ may be represented by Dₛ:={σ|σ=(s₀, a₀, s₁, a₁, . . . , s_{T-1}, a_{T-1}) (sₜ, aₜ, sₜ₊₁)∈D₀}. In this case, σ may denote the trajectory segment, T may denote the total length of the segment, and t may denote a time step, and the time step may be an integer.

The RLT 40 may be defined as a list of trajectory segment groups that correspond to preference levels and are sorted based on the preference levels as follows:

$$L = [ {g}_{1} ≺ {g}_{2} ≺ … ≺ {g}_{s} ]$$

In this equation, the i-th trajectory segment group g; corresponds to preference level i, and may include k trajectory segments gᵢ={αᵢ_{₁}, . . . , σᵢ_{ₖ}} having the same preference level i, and i and k may be natural numbers.

For example, the trajectory segment groups included in the RLT 40 may be sorted in ascending order. That is, for m and n (m>n),σᵢ(σᵢ∈gₘ), which is an element of trajectory segment group gₘ, may have a higher preference than σᵢ(σᵢ∈gₙ), which is an element of trajectory segment group gₙ.

Meanwhile, the controller 120 may collect preference feedbacks for a trajectory pair including a new trajectory segment 20 (see 30), and may determine a trajectory segment group, into which the extracted trajectory segment will be inserted, based on the collected preference feedbacks. The controller 120 may add the extracted new trajectory segment 20 to the RLT by adding the new trajectory segment 20 to the determined trajectory segment group.

In this case, the collected preference feedbacks are ternary preference feedbacks, which are a type of ternary feedback, only preference feedbacks for one trajectory pair may be collected at one time, and preference feedbacks for all segments to be included in the RLT may not be collected at once.

Accordingly, the controller 120 may construct the RLT 40 by repeatedly the tasks of extracting a trajectory segment, collecting preference feedbacks for a trajectory pair including the extracted trajectory segment, determining a trajectory segment group, to which the extracted trajectory segment belongs, based on the collected preference feedbacks, and adding the extracted trajectory segment to the corresponding trajectory segment group.

In this case, the RLT is initially empty, so that the controller 120 may not collect preference feedbacks for any segment σ₁ extracted first, and may initialize the RLT to [{σ₁}] by adding segment σ₁ to the RLT.

The controller 120 may generate a preference pair based on the RLT (see 50). The preference pair may include two trajectory segments and a preference label for the two trajectory segments.

The controller 120 may extract two trajectory segments from the RLT, in which case the controller 120 may generate all possible trajectory segment combination pairs. Furthermore, the controller 120 may assign preference labels based on the preference differences between the trajectory segment combinations included in the trajectory segment combination pairs. For example, the controller 120 may compare the numbers of the trajectory segment groups to which the individual trajectory segments included in the trajectory segment combinations belong, may assign preference labels, and may generate preference pairs by combining the trajectory segment combination pairs and the preference labels.

The controller 120 may train a reward model based on the preference pairs, and may estimate a reward by using the trained reward model. As described above, each of the preference pairs includes a combination of trajectory segments included in the RLT and a preference label based on the preference difference between the combined trajectory segments. Therefore, the reward model may be trained on the preference relationships between all trajectory segments included in the RLT, and thus, may perform listwise reward estimation 60.

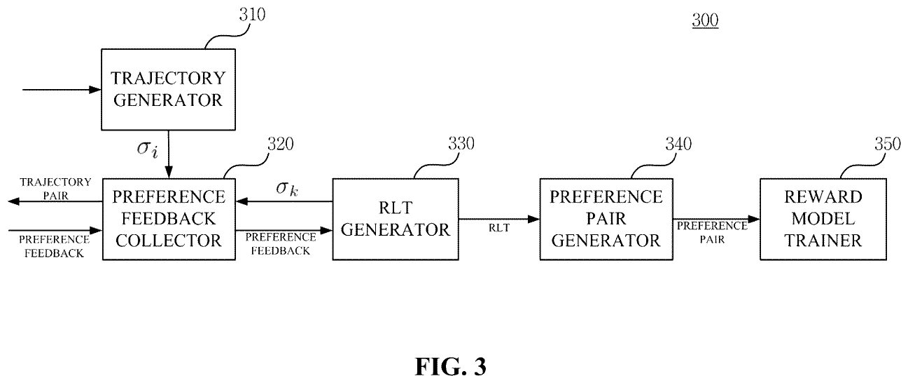

FIG. 3 is a diagram illustrating a framework 300 for performing a reinforcement learning method according to an embodiment. Referring to FIG. 3, the framework 300 may include a trajectory generator 310, a preference feedback collector 320, an RLT generator 330, a preference pair generator 340, and a reward model trainer 350. The controller 120 may execute the program stored in the memory 110 to implement and operate the modules included in the framework 300.

The trajectory generator 310 is a module that generates trajectory segments from an offline dataset, and the controller 120 may generate trajectory segments from the offline dataset by executing the trajectory generator 310.

The controller 120 may generate trajectory segments from the offline dataset according to preset conditions. For example, the controller 120 may generate trajectory segments for all cases from the offline dataset, and may include the generated trajectory segments in a trajectory segment set. Alternatively, the controller 120 may generate a preset number of trajectory segments at one time, and may include the generated trajectory segments in a trajectory segment set.

The controller 120 may extract one trajectory segment from the trajectory segment set, and may transmit the extracted trajectory segment to the preference feedback collector 320.

Meanwhile, the controller 120 may execute the preference feedback collector 320 to collect preference feedbacks for a trajectory pair defined as two trajectory segments. As described above, each of the preference feedbacks is a ternary feedback, which is a response selected from three fixed types of responses, and may be obtained from the input of a user or any respondent. Furthermore, the preference feedback collector 320 may be a module that obtains preference feedbacks for two received trajectories.

In this case, one of the two trajectories included in the trajectory pair is a trajectory segment received from the trajectory generator 310, and may be a trajectory segment extracted (sampled) from the trajectory segment set. The other one may be one of the trajectory segments included in an existing RLT. The other trajectory segment to be included in the trajectory pair may be an element σₖ(σₖ∈gₘ) of any trajectory segment group gₘ. For example, the other trajectory segment to be included in the trajectory pair may be an element of a trajectory segment group corresponding to a median preference level.

The controller 120 may obtain necessary preference feedbacks until the trajectory segment extracted using the preference feedback collector 320 is added to the RLT.

The RLT generator 330 is a module that generates an RLT based on preference feedbacks for a trajectory pair including the extracted trajectory segment. The controller 120 may obtain the RLT by executing the RLT generator 330.

The controller 120 may determine a trajectory segment group to which the trajectory segment, extracted based on preference feedbacks for a trajectory pair defined as a newly extracted trajectory segment σᵢ and a trajectory segment included in an existing RLT, i.e., a trajectory segment σₖ(σₖ∈gₘ) that is an element of any trajectory segment group gₘ, will be added.

When the preferences of the extracted trajectory segment σᵢ and the element σₖ of the any trajectory segment group gₘ are the same, the controller 120 may add the extracted trajectory segment σᵢ to trajectory segment group gₘ. In contrast, when the preferences of the trajectory segment σᵢ and the element σₖ are not the same, the controller 120 may select an element of another trajectory segment group and collect preference feedbacks for a new trajectory pair through the preference feedback collector 320.

For example, in the case of σᵢ<σₖ, an element belonging to any one trajectory segment group of g₁, . . . , gₘ₋₁ may be extracted, preference feedbacks may be collected, and a trajectory segment group to which the trajectory segment σᵢ will be added may be determined based on the collected preference feedbacks. In contrast, in the case of σᵢ>σₖ, an element belonging to any one trajectory segment group of gₘ₊₁, . . . , gₛ may be extracted, preference feedbacks may be collected, and a trajectory segment group to which the trajectory segment σᵢ will be added may be determined based on the collected preference feedbacks.

The controller 120 may recursively use a binary search algorithm based on binary insertion sort to find a trajectory segment group to which the extracted trajectory segment will be added, as shown in Table 1 below. According to an embodiment, merge sort or quick sort may be used to collect multiple segments and then construct an RLT. However, when there is already a partially constructed RLT, binary insertion sort may have higher feedback efficiency.

Algorithm 1 RLT Construction

```
function BINARYSEARCH (σ, low, high, L):
  if low = high then
    insert a new group {σ} to L right behind to g_{low+1}
    (i.e., g_{low} < {σ} < g_{low+1})
  else
    /* Human Feedback */
    $compare σ to {σ}_{s} ∈ {g}_{mid} where mid = ⌈ \frac{low + high}{2} ⌉$
    If σₛ < σ then
      BINARYSEARCH(σ, mid, high, L)
    else if σ < σₛ then
      BINARYSEARCH(σ, low, mid −1, L)
    else
      g_{mid} ← g_{mid} ∪ {σ}
Init: List L = []
repeat
  sample σ₁, σ₂ ... ∈ Dₛ
  If L is empty then
      L ← [{σᵢ}]
  else
      BINARYSEARCH(σᵢ, 0, l, L)
until end of feedback
Output: L
```

Referring to Table 1, when the RLT L is empty, the controller 120 may initialize the RLT by adding a trajectory segment to the RLT. When the RLT is not empty, the controller 120 may compare the preference of the element σₛ of the mid group g_{mid}

$$( mid = ⌈ \frac{low + h i g h}{2} ⌉ )$$

of the trajectory segment group and the preference of the extracted trajectory segment σ, and may add the trajectory segment σ to the trajectory segment group g_{mid} when the preference of the element σₛ and the preference of the trajectory segment σ are the same.

However, in the case of σₛ<σ, the above-described process is repeated recursively for a trajectory segment group having a higher preference than the trajectory segment group g_{mid}. In contrast, in the case of σ<σₛ, the above-described process is repeated recursively for a trajectory segment group having a lower preference than the trajectory segment group g_{mid}.

However, when the trajectory segment group to which the trajectory segment σ will be added is not present (low=high), the controller 120 may generate a new trajectory segment group called g_{low+1} and add the trajectory segment σ to the new trajectory segment group g_{low+1}.

Meanwhile, since a plurality of preference feedbacks are required to add one trajectory segment σᵢ to the RLT, only a small number of trajectory segments may be included in the RLT within a limited feedback budget.

In particular, in the case of using the binary search algorithm shown in Table 1, as the length of the RLT increases, the number of preference feedbacks required to add a trajectory segment to the RLT may increase.

Therefore, the controller 120 may construct a RLT including a plurality of sub-ranked lists by setting a total feedback budget, also setting a sub-feedback budget by dividing the total feedback budget, and generating a plurality of sub-ranked lists within the total feedback budget for a sub-ranked list including a plurality of trajectory segment groups sorted by preference level according to the set sub-feedback budget.

In this case, the controller 120 may generate a sub-ranked list by repeating the tasks of extracting a trajectory segment within the sub-feedback budget as described in Table 1, determining a trajectory segment group, to which the extracted trajectory segment will be added, based on preference feedbacks for trajectory pairs including the extracted trajectory segment and an element of any trajectory segment group included in the sub-ranked list, and adding the extracted trajectory segment to the determined trajectory segment group.

According to the above description, the sample diversity may be increased by adding more trajectory segments to the RLT than those in the case of generating one RLT for the same feedback budget.

Meanwhile, the controller 120 may generate a preference dataset based on the RLT through the preference dataset generator 340. The controller 120 may generate a preference dataset by extracting preference pairs from an RLT instead of independently extracting trajectory segment pairs in the conventional offline preference-based reinforcement learning method. The preference dataset Dᵢ includes a plurality of preference pairs as shown below. Each preference pair (σᵢ_{₁},σᵢ_{₂},lᵢ) may include two trajectory segments σᵢ_{₁} and σᵢ_{₂} and a preference label lᵢ for the two trajectory segments, as shown below.

$${D}_{l} = {\{ ( {σ}_{{i}_{1} ,} {σ}_{{i}_{2} ,} {l}_{i} ) \}}_{i = 1}^{K}$$

The controller 120 may execute the preference dataset generator 340 to extract all obtainable trajectory segment combination pairs by selecting two trajectory segments from among the trajectory segments included in an RLT and to generate a preference pair based on the preference label and trajectory segment combination pair determined by comparing the preferences of the trajectory segments included in the extracted trajectory segment combination pairs.

The preference label may be a ternary label in which preset values are assigned to three types, like the preference feedback. For example, for a preference pair (σᵢ_{₁},σᵢ_{₂},lᵢ), the controller 120 may assign 0 to the preference label lᵢ when the trajectory segment σᵢ_{₁} is preferred over the trajectory segment σᵢ_{₂}, may assign 1 to the preference label lᵢ when the trajectory segment σᵢ_{₂} is preferred over the trajectory segment σᵢ_{₁}, and may assign 0.5 to the preference label lᵢ when the trajectory segment σᵢ_{₂} and the trajectory segment σᵢ_{₁} have the same preference.

The controller 120 may assign preference labels based on the preference levels corresponding to the trajectory segment groups to which to each of the trajectory segments to be included in the extracted trajectory segment combination pairs belongs. For example, for preference pair (σᵢ_{₁},σᵢ_{₂},lᵢ), in the case where trajectory segment of, is an element of trajectory segment group gₘ (i.e., σᵢ_{₁}∈gₘ) and trajectory segment σᵢ_{₂} is an element of the trajectory segment group gₙ (i.e., σᵢ_{₂}∈gₙ), when the trajectory segment σᵢ_{₁}, and the trajectory segment σᵢ_{₂} belong to the same trajectory segment group (i.e., m=n), the controller 120 may assign 0.5 to preference label lᵢ. In contrast, when a preference level corresponding to the trajectory segment group gₘ to which the trajectory segment σᵢ_{₁} belongs is higher than a preference level corresponding to the trajectory segment group gₙ to which the trajectory segment σᵢ_{₁} belongs (i.e., m>n), the controller 120 may assign 0 to preference label lᵢ. In the opposite case (i.e., m<n), the controller 120 may assign 1 to preference label lᵢ.

Meanwhile, the controller 120 may execute the reward model trainer 350 to train the reward model based on the preference pairs included in the preference dataset. The controller 120 may update the parameters of the reward model so that the value of the loss function is minimized using the preference pairs included in the preference dataset. The loss function may be a cross entropy loss function, as defined in Equation 1 below:

$$Loss ( θ ) = - {𝔼}_{( {σ}_{1 ,} {σ}_{2 ,} l ) ∈ {D}_{p r e f}} [ ( 1 - l ) \cdot log {P}_{θ} ( {σ}_{1} ≻ {σ}_{2} ) + l \cdot log {P}_{θ} ( {σ}_{1} ≺ {σ}_{2} ) ] \qquad ( 1 )$$

In Equation 1, (σᵢ_{₁},σᵢ_{₂},lᵢ) is a preference pair, D_{pref} is a preference dataset, P_{θ}(σᵢ_{₁}>σᵢ_{₂}) is the probability that one trajectory segment of, is better than another trajectory segment σᵢ_{₂}, and P_{θ}(σᵢ_{₁}<σᵢ_{₂}) is the probability that trajectory segment σᵢ_{₂} is better than trajectory segment σᵢ_{₁}. P_{θ}(σᵢ_{₁}>σᵢ_{₂}) and P_{θ}(σᵢ_{₁}<σᵢ_{₂}) may be obtained through a preference model using a Bradley-Terry model (a BT model), as defined in Equation 2 below:

$${P}_{θ} ( {σ}_{1} ≻ {σ}_{2} ) = \frac{ϕ ( {r}_{θ} ( {σ}_{1} ) )}{ϕ ( {r}_{θ} ( {σ}_{1} ) ) + ϕ ( {r}_{θ} ( {σ}_{2} ) )} \qquad ( 2 )$$

In Equation 2, φ(x) is a score function, r_{θ} is a reward model, and θ is the parameter of the reward model. In Equation 2, φ(x)=x. φ(x)=x may obtain the same effect as the optimal reward value obtained through the training of φ(x)=exp(x), which is a function commonly used in the Bradley-Terry model (the BT model). Accordingly, the linear score function may amplify the difference in reward value. Especially in the area where the reward value is high, it may amplify the difference in reward value compared to the exponential score function.

Meanwhile, the reward model r_{θ} may be defined as in Equation 3 below:

$${r}_{θ} ( {σ}_{i} ) = {\sum }_{( {s}_{t} , {a}_{t} ) ∈ {σ}_{i}} {r}_{θ} ( {s}_{t} , {a}_{t} ) \qquad ( 3 )$$

In Equation 3, σᵢ is an i-th trajectory segment, sₜ is included in the trajectory segment σᵢ and is a state at time step t, and aₜ is an action at time step t included in the trajectory segment σᵢ.

According to the above description, the reinforcement learning apparatus 100 according to an embodiment may generate more preference pairs even with a small number of trajectory segments by constructing an RLT in which all extracted trajectory segments are sorted by preference level and then generating preference pairs using the trajectory pairs extracted from the RLT, thereby performing the effective training of a reward model even within a fixed feedback budget.

Furthermore, the reinforcement learning apparatus according to an embodiment extracts trajectory segments from an RLT, in which trajectory segments are already sorted by preference level, based on preferences and generates preference pairs, so that a reward model can be trained on the relative relationships between the generated preference pairs, i.e., secondary preferences, thereby increasing the estimation accuracy of the reward model.

For example, for three trajectory segments σₐ, σ_{b}, and σ_{c} having preferences with a relationship of σₐ<σ_{b}<σ_{c} therebetween, when preference pairs are extracted using an RLT, three preference pairs (σₐ,σ_{b},1), (σ_{b},σ_{c},1), and (σₐ,σ_{c},1) may be obtained. Through Equation 3 and the three obtained preference pairs, the reward model may be trained on the fact that the preference of σ_{c} for σₐ is higher than the preference of σ_{c} for σ_{b}.

The term “unit” used in the above-described embodiments means software or a hardware component such as a field-programmable gate array (FPGA) or application-specific integrated circuit (ASIC), and a “unit” performs a specific role. However, a “unit” is not limited to software or hardware. A “unit” may be configured to be present in an addressable storage medium, and also may be configured to run one or more processors. Accordingly, as an example, a “unit” includes components, such as software components, object-oriented software components, class components and task components, processes, functions, attributes, procedures, subroutines, segments in program code, drivers, firmware, microcode, circuits, data, a database, data structures, tables, arrays, and variables.

The functions provided in components and “unit(s)” may be combined into a smaller number of components and “unit(s)” or divided into a larger number of components and “unit(s).”

In addition, components and “unit(s)” may be implemented to run one or more central processing units (CPUs) in a device or secure multimedia card.

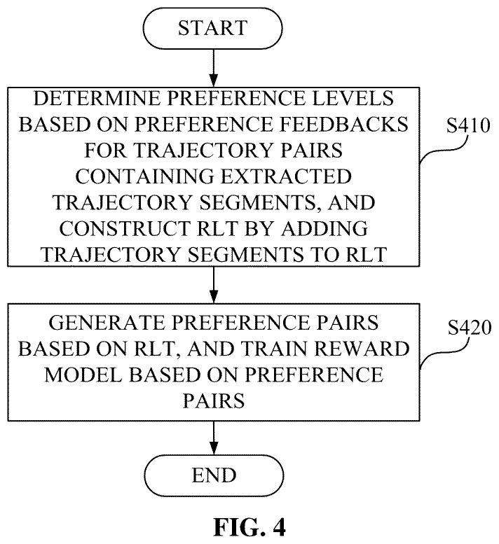

FIG. 4 is a flowchart illustrating a reinforcement learning method according to an embodiment.

The reinforcement learning method shown in FIG. 4 includes steps that are processed in a time-series manner in the reinforcement learning apparatus 100 shown in FIGS. 1 to 3. Accordingly, the descriptions that are omitted below but have been given above in conjunction with the reinforcement learning apparatus 100 shown in FIGS. 1 to 3 may also be applied to the reinforcement learning method shown in FIG. 4.

Referring to FIG. 4, the reinforcement learning apparatus 100 may collect an offline dataset required for the training of a reward model. The offline dataset may be collected by an unknown policy, and may include a plurality of tuples each defined by a current state, an action, and a subsequent state.

Next, the reinforcement learning apparatus 100 may construct an RLT by repeating the tasks of extracting a trajectory segment and adding the trajectory segment to the RLT, in which trajectory segments are sorted by preference level, based on preference feedbacks for a trajectory pair including the trajectory segment a plurality of times in step S410. The RLT may include trajectory segment groups to each of which a group number is assigned in accordance with the preference level thereof. A higher preference level or the larger number of a trajectory segment group may mean a higher preference.

For example, the reinforcement learning apparatus 100 may generate the RLT by using a binary search algorithm. To this end, the reinforcement learning apparatus 100 may construct the RLT by repeatedly the tasks of extracting one trajectory segment and adding the extracted trajectory segment to the RLT based on preference feedbacks for a trajectory pair including the trajectory segment. However, initially, i.e., when the RLT is empty, the reinforcement learning apparatus 100 may directly add the extracted trajectory segment to the RLT without collecting preference feedbacks.

More specifically, the reinforcement learning apparatus 100 may generate a set of trajectory segments including a plurality of trajectory segments generated based on an offline dataset, and may collect preference feedbacks for one trajectory pair including one trajectory segment extracted from a set of trajectory segments and a trajectory segment previously added to an RLT. In this case, the trajectory segment included in the trajectory pair among the trajectory segments in the existing RLT may be determined according to a binary search algorithm, and may be one of the elements of a trajectory segment group corresponding to a preference level having an intermediate value.

The reinforcement learning apparatus 100 may add the extracted trajectory segment to the RLT based on the preference feedbacks collected for the trajectory pair. The preference feedbacks may be ternary preference feedbacks. When the preference of the extracted trajectory segment and the preference of the trajectory segment previously added to the RLT are the same, the extracted trajectory segment may be added to the trajectory segment group to which the trajectory segment previously added to the RLT belongs. Otherwise, the reinforcement learning apparatus 100 may perform the process of collecting and comparing preference feedbacks for a trajectory pair composed of an element of another trajectory segment group and the extracted trajectory segment again.

The reinforcement learning apparatus 100 may generate preference pairs based on the RLT and train a reward model based on the generated preference pairs in step S420. More specifically, the reinforcement learning apparatus 100 may extract all trajectory segment combination pairs that can be combined using two trajectory segments extracted from the RLT, and may generate preference pairs each including two trajectory segments and a preference label assigned to these two trajectory segments by assigning preference labels based on preference levels corresponding to the trajectory segment groups to which the trajectory segments included in the extracted trajectory segment combination pairs belong.

For example, for preference pair (σᵢ_{₁},σᵢ_{₂},lᵢ), in the case where trajectory segment σᵢ_{₁} is an element of trajectory segment group gₘ (i.e., σᵢ_{₁}∈gₘ) and trajectory segment σᵢ_{₂} is an element of the trajectory segment group gₙ (i.e., σᵢ_{₂}∈gₙ), when the trajectory segment σᵢ_{₁} and the trajectory segment σᵢ_{₂} belong to the same trajectory segment group (i.e., m=n), the reinforcement learning apparatus 100 may assign 0.5 to preference label lᵢ. In contrast, when a preference level corresponding to the trajectory segment group gₘ to which the trajectory segment σᵢ_{₁} belongs is higher than a preference level corresponding to the trajectory segment group gₙ to which the trajectory segment σᵢ_{₂} belongs (i.e., m>n), the reinforcement learning apparatus 100 may assign 0 to preference label lᵢ. In the opposite case (i.e., m<n), the reinforcement learning apparatus 100 may assign 1 to preference label lᵢ.

Next, the reinforcement learning apparatus 100 may train a reward model based on the generated preference pairs according to Equations 1 to 3, and may perform reinforcement learning using the trained reward model. More specifically, the reinforcement learning apparatus 100 may update the parameters of the reward model in the direction in which the loss of the reward model calculated by the loss function of Equation 1 is minimized based on the preference pairs. Thereafter, the reinforcement learning apparatus 100 may perform reinforcement learning to find an optimal policy that maximizes the cumulative discount reward while taking into consideration a Markov decision process (MDP) using the trained reward model.

The reinforcement learning method according to an embodiment may generate more preference pairs even with a small number of trajectory segments by constructing an RLT in which all extracted trajectory segments are sorted by preference level and then generating preference pairs using the trajectory pairs extracted from the RLT, thereby performing the effective training of a reward model even within a fixed feedback budget.

Furthermore, the reinforcement learning method according to an embodiment extracts trajectory segments from an RLT, in which trajectory segments are already sorted by preference level, based on preferences and generates preference pairs, so that a reward model can be trained on the relative relationships between the generated preference pairs, i.e., secondary preferences, thereby increasing the estimation accuracy of the reward model.

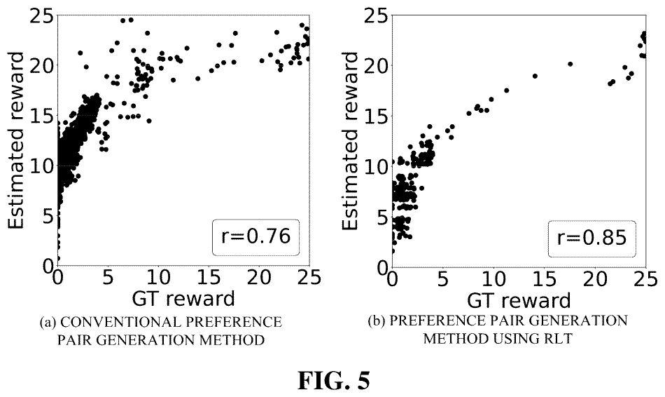

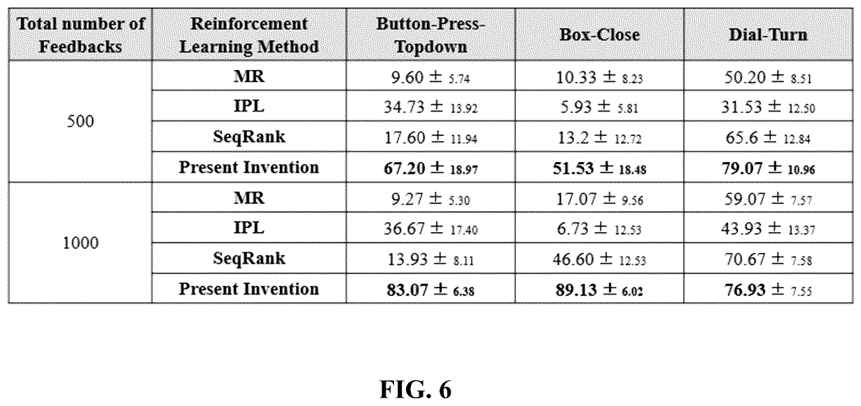

FIGS. 5 and 6 are diagrams illustrating the performance of a reinforcement learning method according to an embodiment.

FIG. 5 illustrates the correlations between the reward values estimated using reward models and actual reward values (GT reward). FIG. 5(a) is directed to a conventional preference-based reinforcement learning method that extracts two trajectory segments from a trajectory segment set without using an RLT and trains a reward model based on preference pairs that each include a preference label assigned based on preference feedbacks for the extracted trajectory segments. FIG. 5(b) is directed to a reinforcement learning method according to an embodiment that generates an RLT and trains a reward model based on preference pairs generated using the generated RLT.

Referring to FIG. 5, it can be seen that the correlation coefficient of the reinforcement learning method (FIG. 5(b)) according to an embodiment has a higher value than the correlation coefficient of the conventional preference-based reinforcement learning method (FIG. 5(a)).

Meanwhile, FIG. 6 illustrates the performance of a reinforcement learning method (the present invention) according to an embodiment and the performance of conventional reinforcement learning methods (MR, IPL, and SeqRank) for specific tasks (Button-Press-Topdown, Box-Close, and Dial-Turn). The Meta World medium-replay dataset was used to evaluate the performance.

In FIG. 6, MR stands for Markovian Reward, which refers to a basic model trained with a multi-layer perceptron layer by using the Markovian reward assumption. IPL stands for Inverse Preference Learning (Hejna, J. et al. “Contrastive Preference Learning: Learning from Human Feedback without RL.” in arXiv preprint arXiv: 2310.13639, 2023), which refers to a reinforcement learning method that learns policies without a reward model. Furthermore, SeqRank (Sequential Preference Ranking, Hwang et al., “Sequential Preference Ranking for Efficient Reinforcement Learning from Human Feedback.” In Advances in Neural Information Processing Systems (NeurIPS), 2023) refers to a reinforcement learning method that sequentially collects preference feedbacks between newly observed segments and previously collected segments and trains a reward model based on the collected feedbacks.

In FIG. 6, the total number of feedbacks refers to a total feedback budget. For example, 500 means that the total feedback budget is 500. The reinforcement learning method according to the present embodiment sets a sub-feedback budget to 100. Accordingly, the RLT may include 5 sub-ranked lists when the total feedback budget is 500, and may include 10 sub-ranked lists when the total feedback budget is 1000.

Referring to FIG. 6, it can be seen that the reinforcement learning method according to the present embodiment exhibits superior performance compared to the conventional reinforcement learning methods for three tasks. In particular, the reinforcement learning method according to the present embodiment exhibits improved performance compared to the other reinforcement learning methods when the total number of feedbacks is small. This may mean that the reinforcement learning method according to the present embodiment can effectively perform the training of a reward model even with a small number of feedbacks.

The reinforcement learning method according to the embodiment described in conjunction with FIG. 4 may be implemented in the form of a computer-readable medium that stores instructions and data that can be executed by a computer. In this case, the instructions and the data may be stored in the form of program code, and may generate a predetermined program module and perform a predetermined operation when executed by a processor. Furthermore, the computer-readable medium may be any type of available medium that can be accessed by a computer, and may include volatile, non-volatile, separable and non-separable media. Furthermore, the computer-readable medium may be a computer storage medium. The computer storage medium may include all volatile, non-volatile, separable and non-separable media that store information, such as computer-readable instructions, a data structure, a program module, or other data, and that are implemented using any method or technology. For example, the computer storage medium may be a magnetic storage medium such as an HDD, an SSD, or the like, an optical storage medium such as a CD, a DVD, a Blu-ray disk or the like, or memory included in a server that can be accessed over a network.

Furthermore, the reinforcement learning method according to the embodiment described in conjunction with FIG. 4 may be implemented as a computer program (or a computer program product) including computer-executable instructions. The computer program includes programmable machine instructions that are processed by a processor, and may be implemented as a high-level programming language, an object-oriented programming language, an assembly language, a machine language, or the like. Furthermore, the computer program may be stored in a tangible computer-readable storage medium (for example, memory, a hard disk, a magnetic/optical medium, a solid-state drive (SSD), or the like).

Accordingly, the reinforcement learning method according to the embodiment described in conjunction with FIG. 4 may be implemented in such a manner that the above-described computer program is executed by a computing apparatus. The computing apparatus may include at least some of a processor, memory, a storage device, a high-speed interface connected to memory and a high-speed expansion port, and a low-speed interface connected to a low-speed bus and a storage device. These individual components are connected using various buses, and may be mounted on a common motherboard or using another appropriate method.

In this case, the processor may process instructions within a computing apparatus. An example of the instructions is instructions which are stored in memory or a storage device in order to display graphic information for providing a Graphic User Interface (GUI) onto an external input/output device, such as a display connected to a high-speed interface. As another embodiment, a plurality of processors and/or a plurality of buses may be appropriately used along with a plurality of pieces of memory. Furthermore, the processor may be implemented as a chipset composed of chips including a plurality of independent analog and/or digital processors.

Furthermore, the memory stores information within the computing device. As an example, the memory may include a volatile memory unit or a set of the volatile memory units. As another example, the memory may include a non-volatile memory unit or a set of the non-volatile memory units. Furthermore, the memory may be another type of computer-readable medium, such as a magnetic or optical disk.

In addition, the memory may provide a large storage space to the computing device. The memory may be a computer-readable medium, or may be a configuration including such a computer-readable medium. For example, the memory may also include devices within a storage area network (SAN) or other elements, and may be a floppy disk device, a hard disk device, an optical disk device, a tape device, flash memory, or a similar semiconductor memory device or array.

The above-described embodiments are intended for illustrative purposes. It will be understood that those having ordinary knowledge in the art to which the present invention pertains can easily make modifications and variations without changing the technical spirit and essential features of the present invention. Therefore, the above-described embodiments are illustrative and are not limitative in all aspects. For example, each component described as being in a single form may be practiced in a distributed form. In the same manner, components described as being in a distributed form may be practiced in an integrated form.

The scope of protection pursued through the present specification should be defined by the attached claims, rather than the detailed description. All modifications and variations which can be derived from the meanings, scopes and equivalents of the claims should be construed as falling within the scope of the present invention.

What is claimed is:

1. A reinforcement learning apparatus for performing offline preference-based reinforcement learning, the reinforcement learning apparatus comprising:
memory configured to store a program and a dataset for performing reinforcement learning; and
a controller provided with at least one processor, adapted to operate by executing the program stored in the memory, and configured to construct a ranked list of trajectories (RLT) by repeating tasks of extracting a trajectory segment and adding the trajectory segment to the RLT, in which trajectory segments are sorted by preference level, based on preference feedbacks for a trajectory pair including the trajectory segment a plurality of times, and to train a reward model based on preference pairs each including two trajectory segments extracted from the RLT and a preference label assigned to the two trajectory segments.

2. The reinforcement learning apparatus of claim 1, wherein the controller collects preference feedbacks for the plurality of trajectory segments in a ternary feedback form.

3. The reinforcement learning apparatus of claim 1, wherein the controller assigns the preference label based on a difference in preference between the trajectory segments included in the preference pair, and the preference label has a ternary feedback form.

4. The reinforcement learning apparatus of claim 1, wherein the controller generates the RLT by adding the extracted trajectory segment to the RLT based on preference feedbacks for a trajectory segment newly extracted from the dataset and a trajectory segment previously included in the RLT.

5. The reinforcement learning apparatus of claim 1, wherein the controller constructs the RLT by, based on a total feedback budget required to generate one RLT and a sub-feedback budget set by dividing the total feedback budget, generating a sub-ranked list through repetition of a process of adding the trajectory segment to the sub-ranked list based on the preference feedbacks for the trajectory pair within the sub-feedback budget a plurality of times and generating a plurality of sub-ranked lists within the total feedback budget.

6. A reinforcement learning method performed by a reinforcement learning apparatus, the reinforcement learning method comprising:
constructing a ranked list of trajectories (RLT) by repeating tasks of extracting a trajectory segment and adding the trajectory segment to the RLT, in which trajectory segments are sorted by preference level, based on preference feedbacks for a trajectory pair including the trajectory segment a plurality of times; and
training a reward model based on preference pairs each including two trajectory segments extracted from the RLT and a preference label assigned to the two trajectory segments.

7. The reinforcement learning method of claim 6, wherein constructing the RLT comprises collecting preference feedbacks for the plurality of trajectory segments in a ternary feedback form.

8. The reinforcement learning method of claim 6, wherein training the reward model comprises assigning the preference label based on a difference in preference between the trajectory segments included in the preference pair, and the preference label has a ternary feedback form.

9. The reinforcement learning method of claim 6, wherein constructing the RLT comprises determining a preference level based on preference feedbacks for a trajectory segment newly extracted from the dataset and a trajectory segment previously included in the RLT and adding the extracted trajectory segment to the RLT based on the preference level.

10. The reinforcement learning method of claim 6, wherein constructing the RLT comprises, constructing the RLT by, based on a total feedback budget required to generate one RLT and a sub-feedback budget set by dividing the total feedback budget, generating a sub-ranked list through repetition of a process of adding the trajectory segment to the sub-ranked list based on the preference feedbacks for the trajectory pair within the sub-feedback budget a plurality of times, and generating a plurality of sub-ranked lists within the total feedback budget.

11. A computer program that is executed by a reinforcement learning apparatus and stored in a non-transitory computer-readable storage medium to perform the method set forth in claim 6.

12. A non-transitory computer-readable storage medium having stored thereon a program that, when executed by a processor, causes the processor to execute the method set forth in claim 6.
